(19) United States
(12) Patent Application Publication
(10) Pub. No.: US 2026/0259076 A1
(43) Pub. Date: Sep. 3, 2026

(54) VIRTUAL FILL LEVEL SENSOR FOR A MOULD OF A CONTINUOUS CASTING MACHINE

(71) Applicant: Primetals Technologies Austria GmbH, Linz (AT)

(72) Inventors: Beate AISTLEITNER, Linz (AT); Thomas DIESENREITHER, Linz (AT); Veit HUMER, Linz (AT); Josef WATZINGER, Reichenau im Muehlkreis (AT)

(21) Appl. No.: 18/995,608

(22) PCT Filed: Jul. 17, 2023
(86) PCT No.: PCT/EP2023/069788

§ 371 Date: Jan. 16, 2025

(30) Foreign Application Priority Data
Jul. 18, 2022 (AT) A 50535/2022

(51) Int. Cl. G01F 23/80; B22D 11/16

(52) U.S. Cl. CPC G01F 23/804; B22D 11/16

(57) ABSTRACT

A method that determines a fill level height (h1) of a metal melt in a mould of a continuous casting machine with a virtual fill level sensor, wherein the metal melt in the mould forms a mould level with the fill level height (h1), and to a virtual fill level sensor suitable therefor. The problem addressed by the method is finding a way to determine the fill level in the mould of the continuous casting machine, so that the start and the end of casting can be carried out fully automatically and without using a radiometric sensor.

### AREA OF THE TECHNOLOGY

The present invention relates to the technical area of continuous casting. In a continuous casting machine, metal melt, for example, made of a steel or aluminum alloy, is cast continuously or semi-continuously to form a strand. The metal melt is cast in a mold, a strand having a thin strand shell forms in the typically cooled mold, wherein the strand is subsequently discharged, for example, drawn out, from the mold. The strand is supported, guided, and cooled further in the strand guide following the mold.

To achieve a high product quality of the continuously-cast strand, attempts are made to keep the meniscus or the fill level height of the metal melt in the mold as constant as possible during the continuous casting. It is known that casting level variations can result in bulging of the strand and strong bulging can result in a strand breakthrough.

Specifically, the invention relates to a method for determining a fill level height of a metal melt, preferably made of a steel or aluminum alloy, in a mold of a continuous casting machine by means of a virtual fill level sensor, wherein the metal melt forms a meniscus having the fill level height in the mold.

### PRIOR ART

To keep the meniscus as constant as possible during the continuous casting, measuring the position of the meniscus or the fill level height of the metal melt in the mold by means of a fill level sensor and, for example, regulating the inflow of metal melt so that the fill level height remains as constant as possible during the continuous casting is known in the prior art.

Since the fill level height is kept constant to approximately ±0.5 mm during the continuous casting, it is sufficient to measure the fill level height during the continuous casting by means of a physical sensor, for example, an electromagnetic sensor. The signal of this sensor is used to regulate the meniscus during the continuous operation of the continuous casting machine. Since the sensor measures the fill level height highly dynamically to approximately 0.1 mm, the measurement range of the sensor is relatively small, for example, a measurement range of 200 mm.

The behavior is very different during the so-called casting start, i.e. when beginning casting, and during the so-called casting end, i.e. when ending a continuous casting procedure, in the continuous casting machine. The phenomenon linked thereto will be explained on the basis of the casting start: A so-called cold strand, which closes the mold fluid-tight on the outlet side, is known to be introduced into the mold before the casting start. During the casting start, metal melt is poured into the mold so that the meniscus rises depending on the supplied quantity of metal melt. After the meniscus has reached a height of, for example, 400 mm, withdrawing the cold strand from the mold is begun. The meniscus would thus sink, which is prevented by the simultaneous pouring of metal melt into the mold. After the beginning of the withdrawal, the meniscus typically still rises somewhat. Since the sensor used to regulate the meniscus during the continuous casting is highly accurate and highly dynamic, but has a relatively small measurement range, it may not be sufficient for certain continuous casting machines to also use the sensor during the casting start, for example, for fully automatic regulation of the casting start.

Two embodiments are known for solving this problem in the prior art:

1) The casting start and the casting end of the continuous casting machine take place manually: This has the problem that the operator has to be on the casting platform or at least in the vicinity of the casting platform in order to be able to control the casting start and the casting end correctly. This is often undesired or not permitted. In addition, an experienced operator is required for a manual casting start, which cannot always be ensured.

2) In addition to the sensor used for regulating the meniscus during the continuous casting, a further physical sensor is used which has a larger measurement range and can therefore also map the changes of the meniscus during the casting start and during the casting end. According to the prior art, this additional sensor often uses a radioactive beam source (radiometric level measurement, see, for example, https://www.berthold.com/en/processcontrol/knowledge-base/radiometric-measurement). This has the disadvantage that radioactive beam sources are costly, have to be additionally installed and calibrated, and in addition the export and import of the sensor often raises problems, for example, with the customs service.

The prior art does not disclose how the meniscus measurement can be carried out in a continuous casting machine so that the casting start and the casting end can be carried out fully automatically and without a radiometric sensor being used. It is preferably not to be necessary to use an additional physical sensor to determine the fill level height of the continuous casting machine for the fully automatic regulation of the casting start or the casting end.

### SUMMARY OF THE INVENTION

The object of the invention is to find a method for determining the fill level in a mold of a continuous casting machine, so that the casting start and the casting end can be carried out fully automatically and without a further fill level sensor, such as a radiometric sensor, being used. In addition, the entire fill level measurement is to be less expensive than comparable solutions using a radiometric sensor and the expense for the installation and calibration is to be low.

On the one hand, this object is achieved by a method as claimed in claim 1. Advantageous embodiments are the subject matter of the dependent claims.

Specifically, this is achieved by a method for determining a fill level height h₁ of a metal melt, preferably made of a steel or aluminum alloy, in a mold of a continuous casting machine by means of a virtual fill level sensor, wherein the metal melt in the mold forms a meniscus having the fill level height h₁, comprising the following method steps:
estimating a volume flow Q_{Ein} of the metal melt flowing to the mold by way of a first state observer in consideration of
   an opening of a valve, preferably a stopper or a slide, for setting a flow rate of the metal melt from a casting vessel, such as a casting distributor, into a casting pipe, wherein the opening of the valve is determined in real time during the continuous casting,
   a geometry of the valve, and
   a geometry of the casting pipe,
estimating a volume flow Q_{Aus} of the metal melt flowing out of the mold by way of a second state observer in consideration of
   a geometry of the mold,
   multiple, preferably at least three, temperature values, wherein multiple temperature sensors determine the temperature values in the mold in real time during the continuous casting, wherein multiple temperature values are assigned to different fill level heights, and
   a casting velocity v_{C} of an at least partially solidified strand, preferably having slab or thin slab cross section, wherein the strand is at least temporarily discharged from the mold during the continuous casting and the casting velocity v_{C} is determined in real time,
calculating the fill level height h₁ as a function of the inflowing volume flow Q_{Ein} and the outflowing volume flow Q_{Aus}, in particular by way of the conditions

$$\dot{{h}_{1}} = \frac{{Q}_{Ein} - {Q}_{Aus}}{{A}_{Quer}} and {h}_{1} ( t ) = \int \dot{{h}_{1}} dt .$$

According to the invention, the fill level height h₁ of the metal melt in a mold of the continuous casting machine is determined by the following steps:

A first state observer estimates the volume flow Q_{Ein} flowing into the mold in consideration of
an opening of a valve s_{Ventil}, preferably a stopper or a slide, to set a flow rate of the metal melt from a casting vessel into a casting pipe, wherein the opening of the valve s_{Ventil} is determined during the continuous casting in real time,
a geometry of the valve A_{Ventil}, and
a geometry of the casting pipe A_{SEN}.

The first state observer operates either continuously in time or preferably discretely in time and “observes” the volume flow Q_{Ein} flowing into the mold. Of course, it is also possible that the state observer uses further input variables to determine Q_{Ein}.

A second state observer estimates the volume flow Q_{Aus} flowing out of the mold in consideration of
a geometry A_{Quer} of the mold,
multiple, preferably at least three, temperature values, wherein multiple temperature sensors determine the temperature values of the mold in real time during the continuous casting, wherein the temperature values are assigned to multiple fill level heights, and
a casting velocity of the strand v_{C}, wherein the casting velocity v_{C} is determined during the continuous casting in real time.

The second state observer can also operate either continuously in time or preferably discretely in time. The second state observer “observes” the volume flow Q_{Aus} flowing out of the mold. Of course, it is also possible here that the state observer uses further input variables to determine Q_{Aus}.

After both Q_{Ein} and Q_{Aus} have been determined, the virtual fill level sensor calculates the fill level height h₁ as a function of the inflowing volume flow Q_{Ein} and outflowing volume flow Q_{Aus}, for example, using the following equations:

$$\dot{{h}_{1}} = \frac{{Q}_{Ein} - {Q}_{Aus}}{{A}_{Quer}}$$

$${h}_{1} ( t ) = \int \dot{{h}_{1}} dt .$$

Of course, it is also possible that the observer does not determine the inflowing and the outflowing volume flow Q_{Ein}, Q_{Aus}, but rather the inflowing mass flow m_{Ein}=ρ·Q_{Ein} and the outflowing mass flow m_{Aus}=ρ·Q_{Aus}.

In particular in so-called fungal molds, it is possible that the cross section of the mold A_{Quer} is not constant over the fill level height h₁ but rather that A_{Quer} is dependent on the fill level height h₁ or A_{Quer} is a function of the fill level height, i.e. A_{Quer}=f(h₁).

In general, the first and second state observers are routine observers, i.e. observers known from the literature, such as a Luenberger or Kalman filter.

In one advantageous embodiment, the first and/or second state observer is an incomplete state observer. An incomplete state observer can be a reduced observer, wherein all process variables which can be measured follow from the measured value here. A further possibility for an incomplete state observer can be a trivial observer which manages without measured values, however, a model then has to be sufficiently accurate that the process variables can be calculated sufficiently accurately without these measured values.

The geometry of the valve can be, for example, the diameter or the area of an opening on the bottom of the casting vessel. The geometry of the casting pipe can be, for example, the internal diameter or the cross-sectional area of the casting pipe through which flow occurs. The geometry of the mold can be described, for example, by the cross-sectional area of the mold cavity.

To increase the accuracy of the first state observer, it is advantageous to additionally take into consideration as input variables a mass m_{Verteiler} and preferably a geometry of the casting vessel or distributor. The fill level in the casting vessel can be determined easily from the mass of the casting vessel, possibly in conjunction with its geometry, wherein a higher fill level is accompanied by a higher inflowing volume flow Q_{Ein}.

In addition, it is advantageous if multiple temperature values are assigned to a first plate, preferably a narrow side plate, of the mold. The rising of the meniscus or the fill level height during the casting start or the casting end can thus be reliably detected. It additionally is advantageous if multiple temperature sensors are arranged at a fill level height, so that any measurement errors can be corrected.

To increase the accuracy, it is advantageous if the second state observer additionally uses, in addition to the multiple temperature values of a first plate of the mold, multiple temperature values of a second plate of the mold, wherein the second plate is preferably arranged opposite to the first plate in the width or thickness direction. Inaccuracies of the sensors or so-called outliers can also be detected by this measure, which increases the accuracy of the virtual sensor.

To be able to measure multiple temperature values along a straight or curved line, for example, it is advantageous to use fiber-optic temperature sensors. However, the invention is in no way restricted to fiber-optic temperature sensors, any temperature sensors can be used, for example, also so-called thermocouples of the type K.

Since the accuracy and the dynamic behavior of the virtual fill level sensor is still worse than that of a physical fill level sensor, it is advantageous, but not absolutely necessary, for the mold to additionally have, in addition to the virtual fill level sensor for observing the fill level height h₁ in a first measurement range, a physical fill level sensor for measuring the fill level height h₂ of the liquid metal in a second measurement range, wherein the second measurement range is smaller than the first measurement range, in particular the first measurement range is at least 2×, preferably 4× larger than the second measurement range.

By means of this embodiment, a physical (for example, an electromagnetic) fill level sensor is additionally used for the regulation of the meniscus during the continuous operation of the continuous casting machine. The physical fill level sensor measures the fill level height of the liquid metal in the mold relatively exactly in a second measurement range. In contrast, the virtual fill level sensor measures the fill level height of the liquid metal in the mold in a first measurement range, wherein, for example, the first measurement range is at least 2×, preferably 4× larger than the second measurement range.

Since the physical fill level sensor only accurately measures the fill level height of the liquid metal in a second measurement range—if the fill level height of the metal melt in the mold is located in the second measurement range—the signal of the physical fill level sensor is used as the fill level height and otherwise, i.e. when the fill level height of the metal melt in the mold is located outside the second measurement range, the signal of the virtual fill level sensor is used as the fill level height.

The object according to the invention is also achieved, on the other hand, by a virtual fill level sensor as claimed in claim 10. Advantageous embodiments are the subject matter of the dependent claims.

Specifically, the object is achieved by a virtual fill level sensor for determining a fill level height h₁ of a metal melt, preferably made of a steel or aluminum alloy, in a mold of a continuous casting machine, wherein the metal melt in the mold forms a meniscus having the fill level height h₁, comprising:
a first state observer for observing a volume flow Q_{Ein} flowing into the mold, wherein the first state observer is connected for signaling to a position sensor of a valve, preferably a stopper or a slide, for setting a flow rate of the metal melt from a casting vessel into a casting pipe, and the position sensor can determine the opening of the valve s_{Ventil} in real time during the continuous casting,
a second state observer for observing a volume flow Q_{Aus} flowing out of the mold, wherein the second state observer is connected for signaling to
   multiple, preferably at least three temperature sensors, wherein the temperature sensors can determine temperature values (T₁ . . . T₃) assigned to different fill level heights in real time during the continuous casting, and
   is connected to a casting velocity sensor, wherein the casting velocity sensor can determine the casting velocity v_{C} of the strand in real time,
a computing unit for calculating the fill level height h₁ as a function of the inflowing volume flow Q_{Ein} and the outflowing volume flow Q_{Aus}.

The use of a fill level measuring system having a virtual fill level sensor as claimed in claim 10 for determining the fill level height h₁ of the metal melt in a first measurement range and a physical fill level sensor for measuring the fill level height h₂ of the metal melt in a second measurement range is preferred, wherein the second measurement range is smaller than the first measurement range, in particular the first measurement range is at least 2×, preferably at least 4× larger than the second measurement range.

In addition, it is advantageous to use a multiplexer for switching the signals for the fill level heights from the virtual and the physical fill level sensor, wherein the multiplexer uses
the fill level height h₁ of the metal melt from the virtual fill level sensor, and
the fill level height h₂ of the metal melt from the physical fill level sensor as input variables and the output variable of the multiplexer
is the fill level height h₂ of the metal melt from the physical fill level sensor if the fill level height h₁ of the virtual fill level sensor is within the second measurement range,
is the fill level height h₁ of the metal melt from the virtual fill level sensor if the fill level height h₁ of the virtual fill level sensor is outside the second measurement range.

### BRIEF DESCRIPTION OF THE DRAWINGS

The above-described properties, features, and advantages of this invention and the manner in which they are achieved will become clearer and more comprehensible in connection with the following description of several exemplary embodiments, which are explained in more detail in connection with the drawings. In the figures:

FIG. 1 shows a first overview diagram,

FIG. 2 shows a schematic representation and flowline of the metal melt from a casting distributed through a valve in a casting pipe and from the interior of the casting pipe through openings (ports) into the mold cavity of a mold,

FIG. 3 shows a schematic representation of the measurement points in a mold and the determined fill level height of the metal melt h₁ during the casting start of a continuous casting machine, and

FIG. 4 shows a second overview diagram with a physical and a virtual fill level sensor.

### DESCRIPTION OF THE EMBODIMENTS

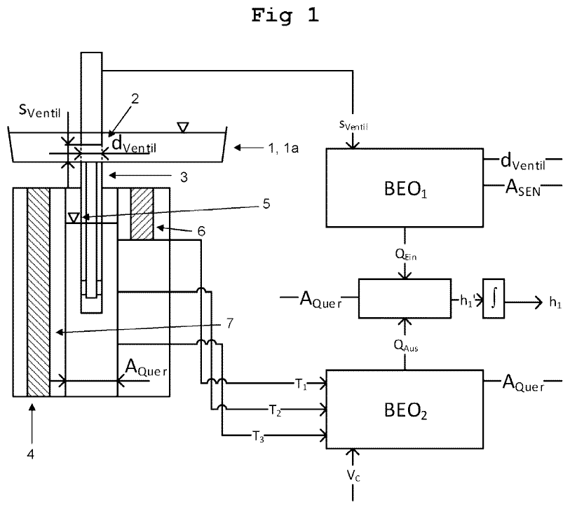

FIG. 1 shows an overview diagram to explain the invention. In continuous casting, metal melt, for example, made of a steel or aluminum alloy, is poured into a casting vessel 1, a casting distributor 1a here. A meniscus represented by a triangle forms in the casting distributor 1a. The metal melt flows out of the casting distributor 1a into a casting pipe 3 (submerged entry nozzle, abbreviated SEN). The flow rate of the metal melt into the casting pipe 3 is set by a valve 2, a stopper here. For this purpose, the stopper can be raised or lowered from the bottom of the casting distributor 1a by a stopper drive (not shown here), so that the stopper has a distance s_{Ventil} to the bottom of the casting distributor 1a. The bottom of the casting distributor 1a has an opening having the diameter d_{Ventil}, which is closed by the stopper before the casting start. After the entry of the metal melt into the casting pipe 3 and the flow through the casting pipe 3, the metal melt flows out in the lower area of the casting pipe 3 through typically multiple openings (ports) and forms a meniscus 5 in the mold 4. It plays no role for the invention whether the openings of the casting pipe are arranged above or below the meniscus 5 as shown. The valve 2 is closed before the casting start of the continuous casting machine, so that no metal melt can flow into the mold 4. The lower side of the mold 4 is closed by a so-called cold strand, so that the mold cavity of the mold is sealed off in the casting direction. During the casting start, initially the valve 2 is opened somewhat so that the metal melt can flow from the casting distributor 1a through the casting pipe 3 into the mold cavity of the mold 4. Initially, the cold strand remains stationary in the mold, so that the volume flow Q_{Ein} flowing into the mold results in a slowly rising meniscus. After the meniscus 5 in the mold 4 has reached a specific height, the withdrawal of the cold strand from the mold is started, so that the warm strand (strand in short hereinafter) following the cold strand is also withdrawn from the mold 4. During the initial casting, the warm strand bonds to the cold strand, so that the casting velocity of the strand corresponds to the withdrawal velocity of the cold strand. The withdrawal of the strand takes place at a casting velocity v_{C}, which can be constant or set variably as a function of time. During the continuous casting operation, the fill level height h₂ of the metal melt in the mold 4 is measured by a physical fill level sensor. The measurement range 6 of the physical fill level sensor is located in the upper area of the mold 4. Since the meniscus 5 in the mold 4 is located outside the measurement range 6 of the physical fill level sensor during the casting start, the physical fill level sensor only has limited or no suitability for contributing to the automation of the casting start. According to the invention, the casting start is controlled by a virtual fill level sensor which determines the fill level height h₁ of the metal melt in the mold 4 in an expanded measurement range 7.

The opening s_{Ventil} and the geometry of the valve 2, as well as the geometry A_{SEN} of the casting pipe 3, are supplied to a first observer BEO₁. The opening s_{Ventil} of the valve is determined for this purpose discretely in time, for example, using a sampling time of 50 ms, and supplied to the first observer BEO₁. The observer contains a dynamic model of the flow of the metal melt from the casting distributor 1a through the valve 2, from the valve into the casting pipe 3, and the outflow of the metal melt through the openings of the casting pipe 3 into the molding cavity of the mold 4. The structure of the first observer, which can be designed, for example, as a so-called Luenberger observer or as a so-called Kalman filter, is known to a person skilled in the art, so that details do not have to be discussed. The first observer BEO₁ determines the volume flow Q_{Ein} flowing into the mold 4.

In addition, a second observer BEO₂ is provided according to the invention which, from the temperature values T₁, T₂, T₃ of multiple temperature sensors in the mold 4, the casting velocity v_{C}, and the parameters for the geometry of the mold A_{Quer}, determines the volume flow Q_{Aus} flowing out of the mold 4. The temperature values T₁, T₂, T₃ and the casting velocity v_{C} are preferably again determined discretely in time, for example, with a sampling time of 50 ms, and supplied to the second observer BEO₂.

From the inflowing volume flow Q_{Ein}, the outflowing volume flow Q_{Aus}, and the geometry of the mold A_{Quer}, the time derivative of the fill level height

$$\dot{{h}_{1}} = \frac{{Q}_{Ein} - {Q}_{Aus}}{{A}_{Quer}}$$

is calculated; from the integration of \dot{h}₁, the fill level height h₁ is calculated, i.e.

$${h}_{1} ( t ) = \int \dot{{h}_{1}} dt .$$

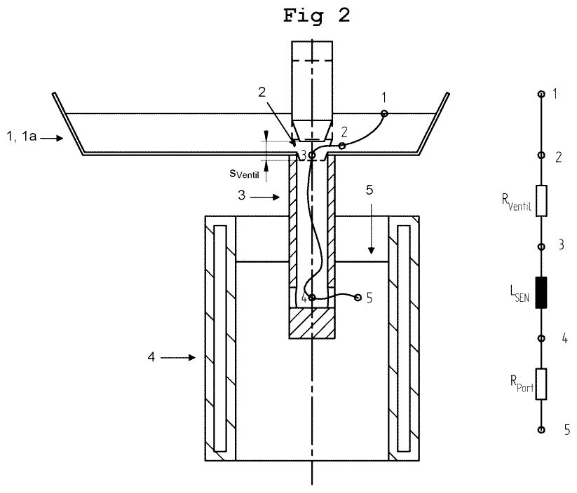

The equations which can be used for the dynamic model of the first observer BEO₁ are specified by way of example. A flow line having five points 1 . . . 5 is shown in FIG. 2. Point 1 is located at the meniscus of the metal melt in the casting distributor 1a. Point 2 is located immediately before the flow through the valve 2. Point 3 is located after the flow through the valve 2. Point 4 is after the flow through the central area of the casting pipe 3 and before the so-called points and point 5 is after the flow through the ports of the casting pipe 3.

The pressure p₂ in point 2 is

$${p}_{2} = {p}_{1} + {ρ}_{Fe} \cdot g \cdot Δ {h}_{1} - \frac{1}{2} {ρ}_{Fe} {\underbrace{{( \frac{{A}_{Ventil}}{Q} )}^{2}}}_{v}$$

with A_{Ventil}=d_{Ventil}*s_{Ventil}, Wherein p₁ specifies the pressure in point 1 (usually p₁=0 is assumed), ρ_{Fe} specifies the density of the metal melt, Δh₁ specifies the height difference between the first and the second point 1, 2, and Q specifies the flow rate. The pressure p₃ in point 3 is p₃=p₂−R_{Ventil}·Q, wherein R_{Ventil} specifies the (linearized) hydraulic flow resistance of the valve 2. The pressure p₄ in point 4 is p₄=p₃+ρ_{Fe}·g·Δh₂−L_{SEN}·\dot{Q}, wherein Δh₂ specifies the height difference between the third and the fourth point 3, 4 and L_{SEN} specifies the hydraulic inductance of the casting pipe 3. The pressure p₅ in point 5 is p₅=p₄−R_{Port}·Q, wherein R_{Port} specifies the (linearized) hydraulic flow resistance of the openings (ports) of the casting pipe 3.

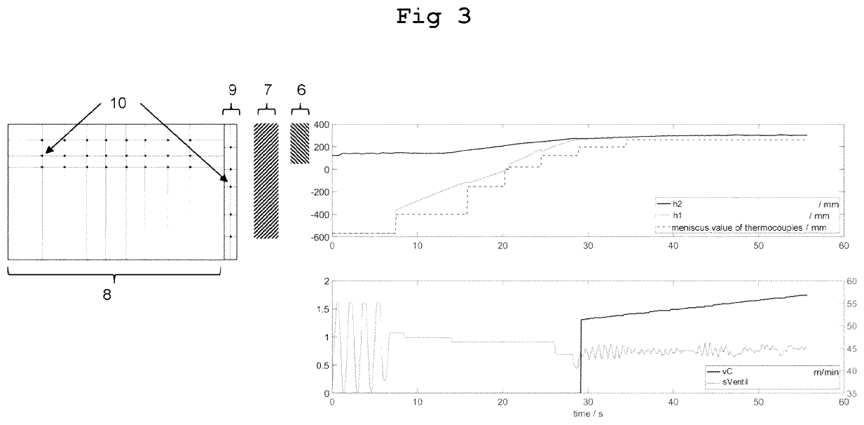

The left side of FIG. 3 shows multiple measurement points 10 of a wide side plate 8 and a narrow side plate 9 of a mold. For example, the measurement points 10 of a wide side plate can be determined by three fiber-optic temperature sensors each having 8 measurement points, which are located in three horizontal drilled holes. It would just as well be possible to use eight fiber-optic temperature sensors each having 3 measurement points. The five measurement points 10 of a narrow side plate can be determined, for example, by a fiber-optic temperature sensor having 5 measurement points. The temperature values at the measurement points 10 shown can optionally be determined using fiber-optic or using conventional temperature sensors, for example, thermocouples of the type K. The second wide side plate (not shown) is embodied identically to the wide side plate 8 shown; the second narrow side plate (not shown) is also embodied identically to the narrow side plate 9 shown. All measurement points 10 shown are used as input variables for the second observer BEO₂ shown in FIG. 1, the associated measurement signal is sampled in real time at a sampling time of 0.5 or 1 second. The measurement ranges 7 and 6 of the virtual and the physical fill level sensor are also shown. As mentioned at the outset, during the casting start, the mold is closed on the outlet side by a cold strand and then the valve, for example, a stopper, between the casting vessel or the casting distributor and the casting pipe is opened. The valve opening sVentil is shown on the bottom left in FIG. 3 over time. The meniscus rises slowly due to the opening of the valve—see the determined fill level height h1 of the virtual fill level sensor. In addition, it can be seen that the physical fill level sensor outputs an incorrect fill level h2, since the meniscus lies outside the measurement range. The physical fill level sensor only indicates the fill level height correctly after the fill level of the metal melt lies within the measurement range 6 of the physical fill level sensor. After somewhat less than 30 seconds after the beginning, the casting velocity vC is increased from 0 to approximately 1.4 m/min. The casting velocity is then continuously increased further slowly. In the wide side plate 8, 8 measurement points 10 of temperature sensors are arranged on each of 4 levels. In the narrow side plate 9, 1 measurement point 10 of a temperature sensor is arranged on each of 5 levels. Of course, it is possible that more or fewer levels and/or more or fewer measurement points per level are arranged. It can be seen well on the right side of the figure that the fill level heights h1 of the virtual sensor determined according to the invention rise slowly and continuously from the time of approximately 8 seconds. It can also be seen that the fill level (shown at the very bottom) derived exclusively from the thermocouples rises suddenly, in contrast.

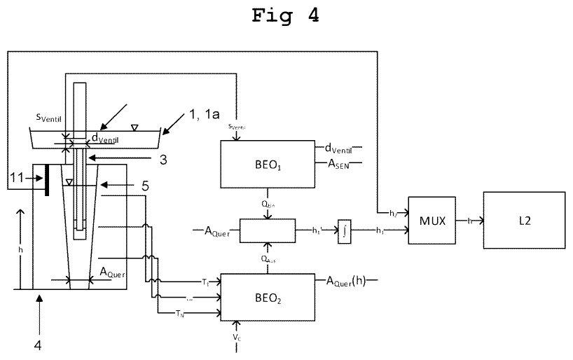

FIG. 4 shows a second overview diagram having a virtual and a physical fill level sensor 11. The virtual fill level sensor functions as described in FIG. 1. In contrast to FIG. 1, the mold 4 is embodied as a funnel mold, wherein the cross-sectional area A_{Quer} of the mold cavity of the mold is not constant, but rather is variable over the height h. In addition, a physical fill level sensor 11 is shown in the figure, which measures a fill level height h₂ in the upper area of the mold 4. Both the fill level height of the virtual fill level sensor h₁ and the fill level height of the physical fill level sensor h₂ are supplied to a multiplexer MUX as input variables, which are dependent on whether the fill level height h₁ of the virtual fill level sensor is located within the measurement range of the physical fill level sensor or not. Specifically, the output variable h of the multiplexer corresponds to the fill level height h₂ of the physical fill level sensor if the fill level height h₁ of the virtual fill level sensor is within the measurement range of the physical fill level sensor. Otherwise, the output variable h of the multiplexer corresponds to the fill level height h₁ of the virtual fill level sensor if the fill level height h₁ of the virtual fill level sensor is outside the measurement range of the physical fill level sensor. The respective output variable h of the multiplexer is applied to a so-called level 2 controller L2, which is used for the regulation of the casting start and possibly the casting end. Of course, it is also possible that the multiplexer MUX is not provided as a discrete component, but rather is implemented as a software block in a regulator. The technical effect is identical.

Although the invention was illustrated and described in more detail by the preferred exemplary embodiments, the invention is not restricted by the disclosed examples and other variations can be derived therefrom by a person skilled in the art without departing from the scope of protection of the invention.

### LIST OF REFERENCE SIGNS

1 casting vessel
1a casting distributor
2 valve
3 casting pipe
4 mold
5 meniscus in the mold
6 measurement range of a physical fill level sensor
7 measurement range of a virtual fill level sensor
8 wide side plate
9 narrow side plate
10 measurement point of a temperature sensor
11 physical fill level sensor
A_{Quer} geometry of the mold
A_{SEN} geometry of the casting pipe
BEO₁, BEO₂ first and second state observer
d_{Ventil} geometry of the valve
h₁ fill level height of a virtual fill level sensor
\dot{h}₁ time derivative of the fill level height of the virtual fill level sensor
h₂ fill level height of a physical fill level sensor
L hydraulic inductance
L2 level 2 controller
MUX multiplexer
Q_{Ein} inflowing volume flow
Q_{Aus} outflowing volume flow
R hydraulic flow resistance
s_{Ventil} opening of the valve
T₁ . . . T_{N} temperature values
v_{C} casting velocity of the strand

1. A method for determining a fill level height h₁ of a metal melt, preferably made of a steel or aluminum alloy, in a mold of a continuous casting machine by means of a virtual fill level sensor, wherein the metal melt in the mold forms a meniscus having the fill level height h₁, comprising the following method steps:
estimating a volume flow Q_{Ein} of the metal melt flowing into the mold by way of a first state observer (BEO₁) in consideration of
an opening of a valve s_{Ventil}, preferably a stopper or a slide, for setting a flow rate of the metal melt from a casting vessel into a casting pipe, wherein the opening of the valve s_{Ventil} is determined in real time during the continuous casting,
a geometry of the valve d_{Ventil}, and
a geometry of the casting pipe A_{SEN},
estimating a volume flow Q_{Aus} of the metal melt flowing out of the mold by way of a second state observer (BEO₂) in consideration of
a geometry A_{Quer} of the mold,
multiple, preferably at least three, temperature values T₁ . . . T₃, wherein multiple temperature sensors determine the temperature values T₁ . . . T₃ in the mold in real time during the continuous casting, wherein multiple temperature values (T₁ . . . T₃) are assigned to different fill level heights, and
a casting velocity v_{C} of an at least partially solidified strand, preferably having slab or thin slab cross section, wherein the strand is at least temporarily discharged from the mold (4) during the continuous casting and the casting velocity v_{C} is determined in real time,
calculating the fill level height h₁ as a function of the inflowing volume flow Q_{Ein} and outflowing volume flow Q_{Aus}, in particular by the conditions
$$\dot{{h}_{1}} = \frac{{Q}_{Ein} - {Q}_{Aus}}{{A}_{Quer}}$$
$${h}_{1} ( t ) = \int \dot{{h}_{1}} dt .$$

2. The method as claimed in claim 1, wherein the first state observer BEO₁ is an incomplete state observer.

3. The method as claimed in claim 2, wherein the first state observer BEO₁ additionally takes into consideration a mass and preferably a geometry of the casting vessel as input variables.

4. The method as claimed in claim 1, wherein the second state observer BEO₂ is an incomplete state observer.

5. The method as claimed in claim 4, wherein the multiple temperature values (T₁ . . . T₃) are assigned to a first plate preferably a narrow side plate, of the mold.

6. The method as claimed in claim 5, wherein the second state observer BEO₂, in addition to the multiple temperature values (T₁ . . . T₃) of a first plate of the mold, additionally uses multiple temperature values (T₁′ . . . T₃′) of a second plate of the mold, wherein the second plate is preferably arranged opposite to the first plate in the width or thickness direction.

7. The method as claimed in claim 1, wherein the temperature sensors are fiber-optic temperature sensors.

8. The method as claimed in claim 1, wherein the mold
in addition to the virtual fill level sensor for observing the fill level height h₁ in a first measurement range,
additionally has a physical fill level sensor for measuring a fill level height h₂ of the liquid metal in a second measurement range,
wherein the second measurement range is smaller than the first range, in particular the first measurement range is at least 2×, preferably 4× larger than the second measurement range.

9. The method as claimed in claim 8, wherein the fill level height of the metal melt in the mold in a second area corresponds to the fill level height h₂ of the physical fill level sensor and the fill level height outside the second area corresponds to the fill level height h₁ of the virtual fill level sensor.

10. A virtual fill level sensor for determining a fill level height h1 of a metal melt, preferably made of a steel or aluminum alloy, in a mold of a continuous casting machine, wherein the metal melt in the mold forms a meniscus having the fill level height h₁, comprising:
a first state observer BEO₁ for observing a volume flow Q_{Ein} flowing into the mold, wherein the first state observer BEO₁ is connected for signaling to a position sensor of a valve, preferably a stopper or a slide, for setting a flow rate of the metal melt from a casting vessel into a casting pipe and the position sensor can determine the opening of the valve s_{Ventil} in real time during the continuous casting,
a second state observer BEO₂ for observing a volume flow Q_{Aus} flowing out of the mold, wherein the second state observer is connected for signaling to
multiple, preferably at least three, temperature sensors, wherein the temperature sensors can determine temperature values (T₁ . . . T₃) assigned to different fill level heights in real time during the continuous casting, and
is connected to a casting velocity sensor, wherein the casting velocity sensor can determine the casting velocity v_{C} of the strand in real time, and
a computing unit for calculating the fill level height h₁ as a function of the inflowing volume flow Q_{Ein} and outflowing volume flow Q_{Aus}.

11. A fill level measuring system comprising
a virtual fill level sensor as claimed in claim 10 for determining the fill level height h₁ of the metal melt in a first measurement range and
a physical fill level sensor for measuring the fill level height h₂ of the metal melt in a second measurement range,
wherein the second measurement range is smaller than the first measurement range, in particular the first measurement range is at least 2×, preferably 4× larger than the second measurement range.

12. The fill level measuring system as claimed in claim 11 comprising a multiplexer, wherein the multiplexer uses
the fill level height h₁ of the metal melt from the virtual fill level sensor, and
the fill level height h₂ of the metal melt from the physical fill level sensor as input variables and the output variable of the multiplexer,
is the fill level height h₂ of the metal melt from the physical fill level sensor if the fill level height h₁ of the virtual fill level sensor is within a second measurement range,
is the fill level height h₁ of the metal melt from the virtual fill level sensor if the fill level height h₁ of the virtual fill level sensor is outside the second measurement range.
